(19) United States
(12) Patent Application Publication
(10) Pub. No.: US 2026/0296692 A1
(43) Pub. Date: Oct. 1, 2026

(54) SYSTEMS AND METHODS FOR ASSISTED LANDING OF UAVs

(71) Applicant: ideaForge Technology Limited, Navi Mumbai (IN)

(72) Inventor: Ankit MEHTA, Navi Mumbai (IN)

(21) Appl. No.: 19/634,627

(22) Filed: Mar. 31, 2026

(30) Foreign Application Priority Data
Mar. 31, 2025 (IN) 202521031588

(51) Int. Cl. B64U 70/20; B64U 10/14; B64U 10/25

(52) U.S. Cl. CPC B64U 70/20; B64U 10/14; B64U 10/25; B64U 2201/10

(57) ABSTRACT

A system and methods for safe landing of an UAV includes a positioning device coupled to a free end of a tether article that is coupled to a deployment mechanism for being retracted or released. The deployment mechanism is fixed to one of the UAV and a landing station. The positioning device includes a first coupler for being coupled to a corresponding second coupler provided on the other of the UAV and the landing station, such that, the positioning device, by coupling of the first coupler and the second coupler, creates a tether link between the UAV and the landing station to enable the deployment mechanism to retract-in the tether article to cause the UAV to be moved to the landing station.

### TECHNICAL FIELD

The present disclosure relates to the field of aerial vehicles. In particular, it pertains to a system and methods for a guided/assisted landing of UAVs, such as in a limited place under difficult conditions, such as caused by wind, turbulence, uneven terrain, fog, or moving landing platform.

### BACKGROUND

Background description includes information that may be useful in understanding the present invention. It is not an admission that any of the information provided herein is prior art or relevant to the presently claimed invention, or that any publication specifically or implicitly referenced is prior art.

Unmanned aerial vehicles (UAVs), popularly known as drones, are used for performing surveillance, reconnaissance, and exploration tasks for military and civilian applications during peace and war time situations. Such UAVs may carry a payload to perform a specific function. While landing of these UAVs on plane surface is easy and comfortable without any problem, but landing in a limited landing area is challenging due to the need for precise control and alignment, which is often complicated by environmental factors such as wind, turbulence, or uneven terrain.

Larger UAVs have more inertia, which makes them less responsive to quick adjustment, are harder to stabilize during decent. In dynamic environments, such as moving platforms or rugged terrain, these factors combine to create significant difficulties in ensuring safe and accurate landing. Therefore, these challenges necessitate improved landing methods for the UAVs to land on any kind of limited surfaces.

Efforts have been made in the past to address abovementioned issues. For instance, Patent Document U.S. Pat. No. 10,007,272B2 discloses a system and method for midair tethering of an unmanned aerial vehicle with a docking station, where the UAV hovers in a hovering position above a docking pad of the UAV docking system based on positioning measurements. An on-board camera images a machine-readable code present on the docking pad. The hovering position of the UAV above the docking pad is adjusted based on imaging of the machine readable code and ranging measurement of the docking pad. The document further discloses that a tether can be extended from the UAV towards the docking pad. The hovering position of the UAV and extension of the tether can be adjusted such that a mating device present on a distal end of the tether engages with a coupling device provided at the UAV docking pad. The tether can be reeled in to the UAV to assist in lowering the UAV from the hovering position to a landing position on the docking pad.

Another Patent Document, DE102015111224 B4 discloses method for launching and recovery device for a towing kite comprising a control gondola which is arranged below the towing kite and is connected to it via several lines for joint flight. A base station is provided with a towing cable receiving device for pulling in and releasing a towing cable which connects the base station to the control gondola. A guide mast with a guide cable receiving device for a guide cable is provided, which connects the towing kite to the guide cable receiving device in a launching phase and in a recovery phase. The guide cable has a base cable station, a towing kite cable section and a detachable coupling device which comprises a first coupling element connected to the towing kite cable section and a second coupling element connected to the base cable section, which can be detachably coupled to one another in order to connect the base cable station to the towing kite rope section to be detachably connected to one another.

While the referred documents provide systems and methods for midair tethering of an unmanned aerial vehicle with a docking station for an assisted/guided landing of the unmanned aerial vehicle, there is a possibility to provide an improved and more efficient solution for the above mentioned problem.

There is, therefore, a requirement to address the abovementioned drawbacks and limitation of the landing methods for the UAVs to land on any kind of limited surfaces fur unhindered use of UAVs under difficult environmental conditions.

### OBJECTS OF THE INVENTION

A general object of the present disclosure is to provide a system and methods for efficient targeted landing of an unmanned aerial vehicle in limited areas under difficult environmental conditions.

An object of the present disclosure is to provide systems and methods for guided landing of UAVs using a tether.

Another object of the present disclosure is to provide improved and more efficient system and method for guided landing of UAVs using a tether.

Another object of the present disclosure is to provide a system that works autonomously for a safe landing of a UAV under difficult environmental conditions.

### SUMMARY

Aspects of the present disclosure relate to the field of aerial vehicles. In particular, it pertains to a system and methods for precise landing of an unmanned aerial vehicle in a limited place under difficult environmental conditions, such as wind, fog, moving landing station, etc., to name a few. Specifically, the present disclosure pertains to one or more methods using a positioning device having tether with a coupling attachment facilitating landing of the UAV through a deployment mechanism.

In an aspect, the proposed system for safe landing of an UAV includes a deployment mechanism; a tether article operatively coupled to the deployment mechanism for being retracted and released by the deployment mechanism; and a positioning device coupled to a free end of the tether article. In an aspect, upon detecting a requirement for landing of the UAV, the positioning device is configured to create, using the tether article, a tether link between the UAV and a landing station such that on creation of the tether link, the deployment mechanism winds the tether article to cause the UAV to be moved to the landing station.

In one or more embodiments, the system may include a coupling mechanism comprising a set of couplers to facilitate creation of the tether link between the UAV and the landing station.

In an implementation of the proposed system, the deployment mechanism may be fixed to the landing station, and the set of couplers are configured with an under belly of the UAV and an upper side of the positioning device to facilitate coupling of the positioning device with the UAV such that the set of couplers enable coupling of the positioning device to the UAV, thereby establishing the tether link between the UAV and the landing station.

In an alternate implementation of the proposed system an embodiment, the deployment mechanism may be fixed to under belly of the UAV, and the set of couplers may be configured with under belly of the positioning device and the landing station such that the set of couplers enable coupling of the positioning device to the landing station thereby establishing the tether link between the UAV and the landing station.

In an embodiment, the coupling mechanism may be any one or more of a magnetic couplers, spring loaded connectors, suction cups, and mechanical interlocking device to securely couple the positioning device with the UAV or the landing station, once the positioning device is in close proximity of the UAV or the landing station.

In an embodiment, the positioning device may be any of a mini UAV, an aerostat and a balloon, equipped with sensors, a GPS system and navigation means to autonomously navigate and position itself above the landing station or under the UAV.

In an embodiment, the positioning device may include a controller, a communication module, and sensors to execute command received from the UAV, and the UAV and the positioning device remain in communication with each other through designated radio frequency.

In an embodiment, the controller may be configured to use artificial intelligence for precise and independent control of navigation means based on the shared real-time data from the UAV or the landing station.

An aspect of the present disclosure relates to a method for safe landing of an UAV, where in a first implementation, the method includes steps of (i) flying the UAV over a landing station at a certain threshold distance from the landing station; (ii) launching from the UAV, a positioning device coupled to a deployment mechanism through a tether article, and the deployment mechanism is fixed to an underbelly of the UAV; (iii) docking the positioning device, through a set of couplers configured with the positioning device and the landing station, with the landing station; and (iv) actuating the deployment mechanism to retract-in the tether article for lowering the UAV and a safe landing of the UAV over the landing station.

In an embodiment, the method may further comprise the step of establishing a communication link between the UAV and the landing station before launching the positioning device.

In an embodiment, wherein the step of launching the positioning device may include lowering the positioning device below the UAV to a safe height from the landing station by release-out the tether article using the deployment mechanism.

In an embodiment, the method may further comprise the step of: aligning the positioning device, using one or more of sensors, GPS system and navigation means, which enable the positioning device to autonomously navigate, and position itself over the landing station for docking with the landing station.

In an aspect, the method in a second alternate implementation includes steps of (i) receiving, by a landing station, an indication of a requirement of landing of a UAV at the landing station; (ii) launching a positioning device coupled to a deployment mechanism through a tether article, wherein the deployment mechanism is fixed on the landing station, for positioning and hovering of the positioning device below the UAV; (iii) docking the positioning device, through a set of couplers configured with the UAV and the positioning device, with the UAV; and (iv) actuating the deployment mechanism to retracting-in the tether article for lowering the UAV and a guided landing of the UAV over the landing station.

In an embodiment, the step of receiving the indication of a requirement of landing of a UAV at the landing station may be based on the landing station receiving a signal from the UAV or based on identifying the incoming UAV independent of any signal from the UAV through a sensor located at the landing station.

In an embodiment, the predefined pattern of flying of the UAV over the landing station as an indication of the requirement of landing at the landing station. In an embodiment, the flying of the UAV near a certain threshold distance of the landing station may be taken as an indication of the requirement of landing at the landing station.

In an embodiment, the method may further comprise the step of: aligning the positioning device, using one or more of sensors, GPS system and navigation means, which enable the positioning device to autonomously navigate, and position itself under the UAV for docking with the UAV.

Yet another aspect of the present disclosure related to a positioning device for assisted landing of an UAV. The disclosed positioning device is coupled to a free end of a tether article, which tether article is coupled to a deployment mechanism for being retracted-in or released-out. The deployment mechanism is fixed to one of the UAV and a landing station. The positioning device includes a first coupler for being coupled to a corresponding second coupler provided on the other of the UAV and the landing station, such that, the positioning device, by coupling of the first coupler and the second coupler, creates a tether link between the UAV and the landing station for deployment mechanism to retract-in the tether article to cause the UAV to be moved to the landing station.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates an exemplary block diagram of the proposed system for a safe and guided landing of an UAV with help of a positioning device in limited space, in accordance with one or more embodiments of the present disclosure.

FIGS. 2A and 2B illustrate exemplary schematic diagrams showing landing of a UAV using a first embodiment of the system of FIG. 1, where the positioning device is coupled to the UAV, where the positioning device is coupled to the UAV through a tether article and deployment mechanism.

FIGS. 3A and 3B illustrate exemplary schematic diagrams showing landing of a UAV using a second embodiment of the system of FIG. 1, where the positioning device is coupled to the landing station through a tether article and deployment mechanism.

FIG. 4 illustrates an exemplary method flow diagram for the proposed method for a safe and guided landing of an UAV with help of a positioning device in limited space using the first embodiment of the system of FIG. 1.

FIG. 5 illustrates an exemplary method flow diagram for the proposed method for a safe and guided landing of an UAV with help of a positioning device in limited space using the second embodiment of the system of FIG. 1.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Embodiments explained herein relate to the field of aerial vehicles. In particular, it pertains to a system and methods for a guided landing of UAVs, such as in a limited place under difficult conditions, such as caused by wind, turbulence, uneven terrain, fog, or moving landing platform. The system and methods of the present disclosure are helpful during application of the UAVs in areas where small clusters of plane surfaces are available but no surface is wide enough that allows safe and secure landing of UAVs independently.

Specifically, the present disclosure provides systems and methods for a tethered landing of a UAV. Specifically, the system and methods of the present disclosure are based on a positioning device that autonomously and efficiently enables creation of a tethered link between the UAV and the landing station such that after the tether link is established a deployment mechanism can retract in the tether (also referred to as tether article) for a safe guided landing of the UAV. The positioning device can have its own navigation capability, such as a mini UAV or other such device, which enables the positioning device to move and create a the tethered link while the main UAV hovers near the landing station or moves in a predefined pattern at a safe distance from the landing station..

In different embodiments, the positioning device can be configured with the UAV or with the landing station. When the positioning device is configured with the UAV, as in the first embodiment, the deployment mechanism can be fixed to one of the UAV or the positioning device, and coupled to the other of the positioning device or the UAV through the tether article for retracting in and releasing out, as required. The positioning device can be accommodated within or over an underbelly of the UAV and released by releasing out the tether article by the deployment mechanism, when required. In the other hand, when the positioning device is configured with the landing station, as in the second embodiment, the deployment mechanism can be fixed to the landing station, and coupled to the positioning device through the tether article for retracting in and releasing out, as required, to create a tether link with a UAV, the positioning device can take off facilitated by releasing out the tether article by the deployment mechanism.

The positioning device can be any of a mini UAV, an aerostat and a balloon equipped with sensors, a GPS system and other navigational means to navigate and position itself above the landing station or under the UAV. Specifically, the positioning device comprises aligning/positioning mechanism which enables the positioning device to align itself with the UAV or the landing station, as the case may be, for attachment therewith to complete the tethered link between the UAV and the landing station. The system can include a coupling mechanism to facilitate attachment of the positioning device with the UAV or the landing station, as the case may be, for creation of the tether link between the UAV and the landing station. The coupling mechanism can include a set of couplers comprising a first coupler positioned on the positioning device, and a second coupler that is positioned, in the first embodiment, on the landing station, or on the UAV, in the second embodiment. The coupling mechanism helps to couple the positioning device with the landing station or the UAV, after the positioning device has positioned itself above the landing station or under the UAV as the case may be, to complete the tethered link between the UAV and the landing station, before the deployment mechanism starts retracting in the tether article for the guided landing of the UAV.

In an embodiment, the system is configured to dynamically adjust and execute navigation control, ensuring precise and autonomous navigation means of the positioning device processing the shared or independent real-time data from the UAV or the landing station.

In an embodiment, the system is configured to dynamically adjust and execute navigation control, ensuring precise and autonomous navigation means of the positioning device, processing the real-time imaging sensor data from the imaging sensor present on one or more of the positioning device, the UAV and the landing station. By processing the images, identification of position of the UAV or identification of position of the landing station can be done.

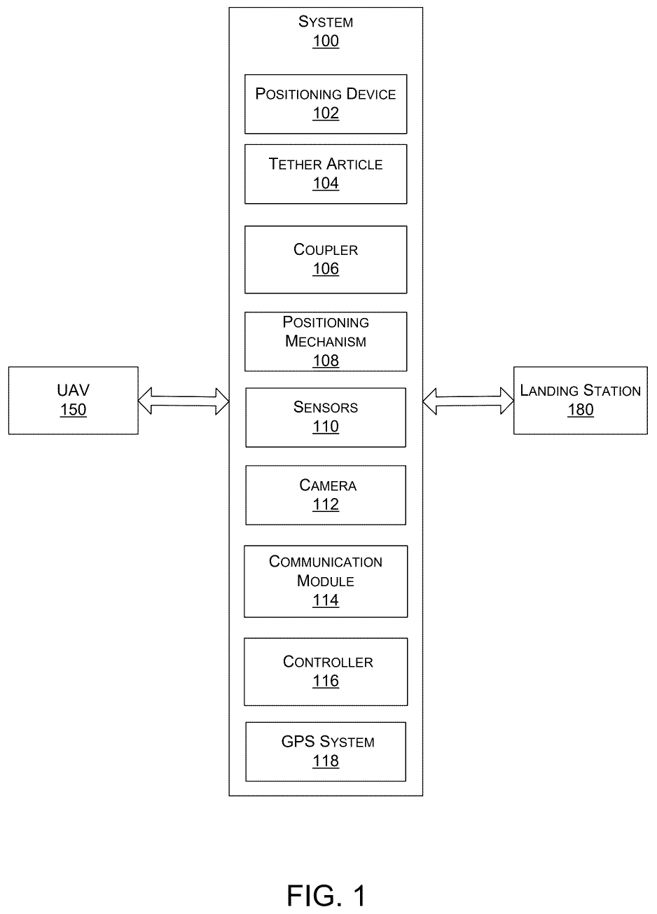

Referring now to FIG. 1 where an exemplary block diagram for the proposes system 100 for safe landing of an UAV 150 on a landing station 180 with help of a tether article, the system 100 includes positioning device 102, a tether article 104 and a deployment mechanism 108. In an aspect, upon identifying a UAV near the landing station or detecting a requirement for landing of the UAV, the positioning device 102 is configured to create, using the tether article 104, a tether link between the UAV, such as UAV 150, and a landing station, such as the landing station 180. On creation of the tether link, the deployment mechanism 108 can retract-in the tether article 104 to cause the UAV 150 to be moved to the landing station 180.

The system 100 can further include a coupling mechanism 106 (also referred to as couplers 106) that includes a pair of couplers 106, one or more sensors 110 located on the positioning device 102, a camera 112, a communication module 114 for communication between the UAV and the positioning device 102, a GPS system 118 and a controller 116. Other devices such as a search light may also be present on the positioning device 102 for ease of locating the UAV 150 or the landing station 180, under low visibility conditions.

The coupling mechanism 106 can include a set of couplers comprising a first coupler positioned on the positioning device, and a second coupler that is positioned, in the first embodiment, on the landing station, or on the UAV, in the second embodiment.

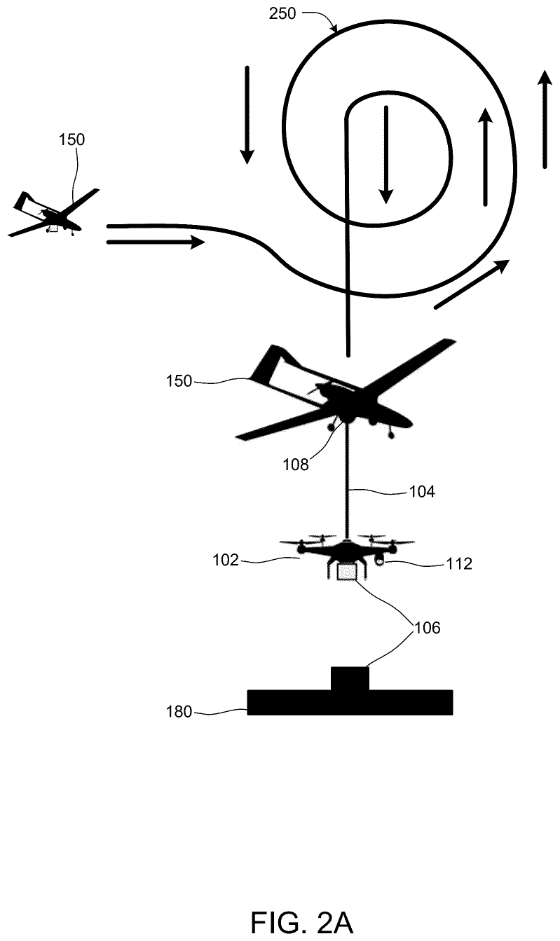

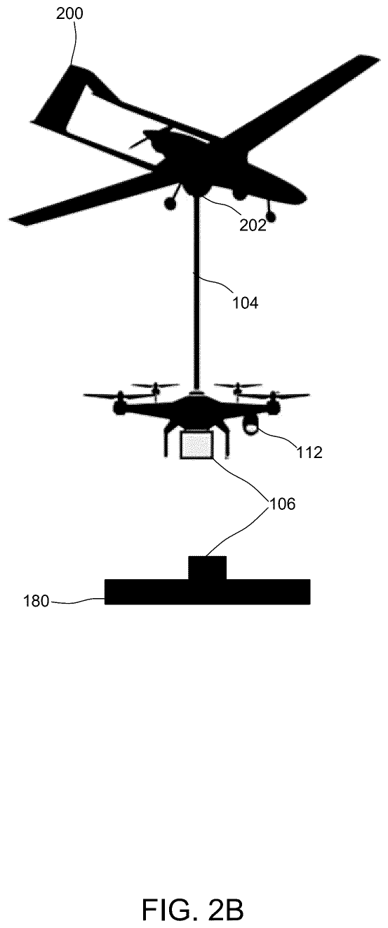

Referring to FIGS. 2A and 2B, in a first embodiment of implementation of the proposed system 100, the deployment mechanism 108 can be fixed to the landing station 180, and the set of couplers 106 can be configured with an under belly of the UAV 150 and an upper side of the positioning device 102 to facilitate coupling of the positioning device 102 with the UAV 150.

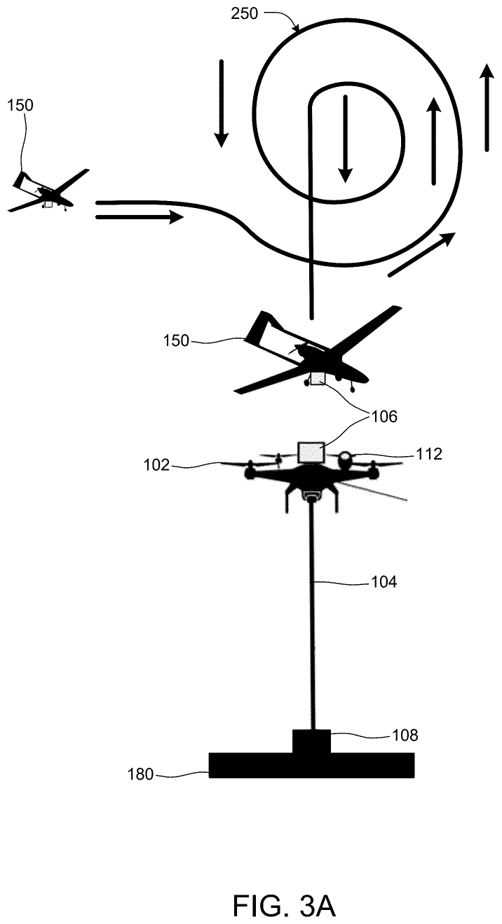

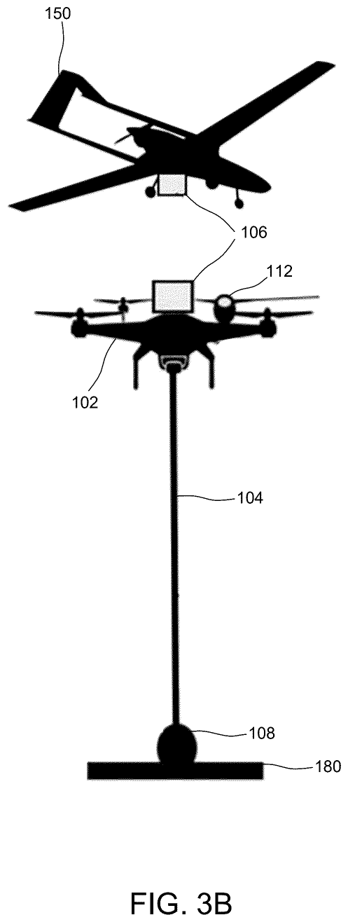

Referring to FIGS. 3A and 3B, in a second embodiment of implementation of the proposed system 100, the deployment mechanism 108 can be fixed to under belly of the UAV 150, and the set of couplers 106 can be configured with under belly of the positioning device 102 and the landing station 180 respectively.

In an embodiment, the coupling mechanism 106 may include the pair of couplers, such as but not limited to at least one of a magnetic couplers, spring loaded connectors, suction cups, and mechanical interlocking devices, to securely couple the positioning device 102 with the UAV 150 or the landing station 180, once the positioning device 102 is in close proximity of the UAV 150 or the landing station 180.

In an embodiment the positioning device 102 can be any of a mini UAV, an aerostat and a balloon, equipped with sensors, a GPS system and navigation means to autonomously navigate and position itself above the landing station or under the UAV.

In an embodiment, the controller 116 provided in the positioning device 102 can be in communication with the UAV 150 through the communication module 114. The UAV 150 can in turn be in communication with the landing station such that the controller 116 executes commands received from the UAV 150. In addition, the controller 116 can be configured to dynamically adjust and execute navigation control, ensuring precise and autonomous navigation means of the positioning device 102 processing the shared or independent real-time data from the UAV 150 or the landing station 180, received through the UAV 150.

In an embodiment, the deployment mechanism 108 can be light weight, durable to prevent any weight penalty, when fixed to the UAV, as in the first embodiment. The tether article 104 can be made of strong but flexible materials, such as but not limited to Kevlar or carbon-fiber-reinforced polymers, to ensure strength without adding significant weight. As can be understood, in the second embodiment, where the winching mechanism is located on the landing station 180, the positioning device 102 would be required to carry the weight of the tether article 104, therefore, keeping the tether article 104 light weight is of importance to keep the positioning device 102 small.

In each of the embodiments, power supply to the positioning device 102 can be through the tether article 104, such as from the UAV 150, as in the first embodiment, or the landing station 180, as in the second embodiment, so as to minimize weight of the positioning device and make it more agile.

In an embodiment, the deployment mechanism 108 can be powered by a bidirectional servo motor for smooth two way motion for releasing-out and retracting-in of the tether article 104. In one embodiment, the deployment mechanism 108 can include a braking system to lock the tether article 104 in position along with tension sensors to monitor and prevent overstretching or snapping. There can be a real-time monitoring of the length of the released out tether article 104 with automated stop points to avoid overextension.

In an embodiment, the system 100 can include an emergency retrieval mechanism, like an automated deployment mechanism reaction if the positioning device 102 detects a critical fault or loss of power supply. The suspension and retrieval system can be any of a spool and motor mechanism, tension driven pulley system, spring-loaded reel, linear actuator with guide, electromagnetic control system, rack and pinion mechanism, belt driven mechanism, and rotary drum mechanism.

In an example embodiment, the deployment mechanism 108 can be a device not limited to a winch mechanism, a capstan/friction drive mechanism, a pinch roller/feed roller mechanism, a gravity-assisted drop with controlled brake system, a spring-loaded reel, or a pneumatic or hydraulic deployment system. In one example aspect, the tether article 104 may have an alternative not limited to a flexible expandable coil spring. The flexible expandable coil spring may not require winding-unwinding operation to be performed by any deployment mechanism. The coil spring can be simply released or extended by a flying force of the positioning device 102 and retracted by self-retaining force. For example, the UAV 150 may release the flexible expandable coil spring and allow the positioning device 102 to be coupled with the landing station 180. Further, the self-retaining force of the flexible expandable coil spring may direct the UAV 150 to be lowered towards the end of coil spring in connection with the positioning device 102 coupled with landing station 180. Similarly, the flexible expandable coil spring may perform same function when the positioning device 102 take-off from the landing station 180 towards the UAV 150 for coupling.

In an embodiment, the coupling mechanism comprising the first and the second couplers 106, can be, but not limited to, a magnetic coupler, spring loaded connectors, suction cups, and mechanical interlocking devices, to securely couple the positioning device 102 either with the UAV 150 or with the landing station 180, as the case may be, once the positioning device 102 is in a close proximity of the UAV 150 or the landing station 180.

In an embodiment, dynamic adjustment mechanism for the tether article 104 is present like a shock absorbing mechanism to counteract jerks caused by the turbulence or the movements of the positioning device 102. A detachable tether mechanism is also present, like a quick-release tether article 104 for emergencies, enabling the positioning device 102 to fly independently, if needed.

In an embodiment, power to the positioning device 102 is supplied through independent batteries which can be charged or replaced as the requirement may be. In an exemplary embodiment, power to the positioning device 102 is supplied through the tether article 104, or a wireless power transmission system from the UAV 150 to the positioning device 102, in case the positioning device 102 faces a low battery condition or battery draining conditions due to multiple attempts of landing due to undesirable circumstances.

In an embodiment, in implementation of the wireless power transmission mode, the UAV 150 can include a transmission coil and the positioning device 102 can include a receiving coil, and the induced power mechanism may be performed autonomously for the power transfer without any ground support.

In an embodiment, the the sensors 110, the GPS 118, the camera 112, and the communication module 114 and controller 116 provided on the positioning device 102 can work as navigational aids to execute command and positioning. The command may be generated from the UAV 150 or the landing station 180 to be communicated to the positioning device 102 through the UAV 150 through the communication module 114.

In an embodiment, the camera 112, and other similar devices, such as the search light, can be positioned on the positioning device 102 to suite the embodiment, i.e., the first or the second embodiment.

In an embodiment, the communication between the UAV 150, the positioning device 102, and the landing station 180 can be performed either through Radio Frequency communication on a specific RF frequency, or through digital data link like Wi-Fi network, UHF or VHF, or RFID technology, etc.

In an embodiment, the landing station 180 may have one or more landing pads with independent coupler attachments to each of the landing pads to facilitate landing of multiple UAVs 150. In such cases, additional sets of sensors can be provided in the positioning devices 102 to select at least one coupling point free out of multiple coupling points. The coupling points, besides sensors, can be selected by selecting specific IDs related to the coupling points, where IDs can be markings such as QR code, bar code, etc., readable by an imaging sensor.

In an embodiment, the landing station 180 can be arranged with a mission control system which initiates the high-level commands automatically. The positioning device 102 can perform automatically, or semi-automatically, and along with the landing station 180 mission control system, can provide high level instructions like Fail-safe, return to dock in case of signal loss or low battery condition. The mission control center can be aware of the UAV 150 approach. The mission control center can transmit commands to the positioning device 102 to prepare for connection. The landing station 180 can also have GPS receiver and communication module to provide intercommunication facility.

In an embodiment, upon a landing requirement, the UAV 150 can hover over the landing station 180 at a safe height, as the positioning device 102 establishes the tether link between the UAV 150 and the landing station 180. For UAVs that are not capable for hovering, such as fixed wing UAVs, the UAV 150 can fly over the landing station 180 in a pre-defined pattern, such as a circling pattern, with a reducing radius of the circular path. Thereafter the positioning device 102 can be launched from the UAV 150, as in the first embodiment, or from the landing station 180, as in the second embodiment.

In an embodiment, when the UAV 150 can use one or more sensors, such as a imaging sensor, LiDar, ultrasonic sensor, infrared sensor, proximity sensor, to name a few, to measure height above the landing station 180. A global navigation system may also be used to position of the UAV 150 in vicinity of the landing station 180 with an accuracy of 10 to 20 feet. A camera can also help to capture the images of the landing station 180 which helps to pin point the landing pad using artificial intelligence or image processing.

In an embodiment, in each of the embodiments, the UAV 150 can make a radio contact with the landing station 180 using the communication module through designated radio frequency.

In an embodiment, when UAVs are required to land on moving objects like ship, the landing pad may be provided with suspension mechanism to provide counter mechanism to the huge turbulences faces by the ship. The suspension mechanism stabilizes the landing pad against this turbulence so that a stable platform is provided for coupling of the UAV 150 with the positioning device 102.

In an embodiment, dynamic adjustment mechanism, such as a shock absorbing mechanism, can be provided for the tether article 104 to counteract jerks caused by the turbulence or the movements of the positioning device 102. A detachable tether mechanism, such as a quick-release tether 104, can also be provided and is within the scope of the present disclosure, for emergencies, enabling the positioning device 102 to fly independently, if needed.

In an exemplary embodiment, a remote pilot can have independent links with both the UAV 150 and the positioning device 102. The UAV 150 and the positioning device 102 operate on a separate RF frequencies and the remote pilot switches between them as per requirements of the operation. The positioning device 102 can perform precise maneuver without relying on the UAV's control systems reducing latency and potential errors. The UAV 150 basically focuses on providing a stable platform, while the positioning device 102 manages close-range operations.

In an embodiment, the direct command for controlling the operation of the positioning device 102 can be done through the UAV 150 itself. It also acts as relay station for the commands from the remote pilot to the positioning device where the remote pilot sends commands from to the UAV 150, and the UAV 150 relays these commands to positioning device 102 and a feedback from the positioning device 102 is transmitted back to the remote pilot via the UAV 150 for positioning.

In an embodiment, the UAV 150 can also efficiently be landed in the limited area using the positioning device 102 where the positioning device 102 is positioned between the UAV 150 and the landing station. However, the difference between the first embodiment (FIGS. 2A and 2B) and the second embodiment (FIGS. 3A and 3B), is that in the first embodiment, the positioning device 102 is housed under the belly of the UAV 150. The belly of the UAV 150 may be configured aerodynamically in such a way that the positioning device 102 can be housed securely under the belly of the UAV 150 inside spring-loaded or motorised doors. The doors can help to minimise drag, in the closed position, such as when the UAV 150 is landing or during flight of the UAV 150.

In the first embodiment, the positioning device 102 can be coupled with the UAV 150 through the tether article 104. The first or the top end of the tether article 104 is securely coupled with a pulley of the deployment mechanism configured with the UAV 150 under the belly of the UAV 150, and the second or bottom end is attached with the positioning device 102. The positioning device 102 includes coupler 406 positioned at the belly area of the positioning device 102.

In an alternate arrangement, the deployment mechanism 108 can be placed on the top of the positioning device 102 and the tether article 104 can be connected between the deployment mechanism 108 on the positioning device 102 and the belly of the UAV 150. Once the landing station 180 is detected by the UAV 150, the deployment mechanism 108 may release itself along with the positioning device 102 from the UAV 150. Further as the positioning device 102 is coupled with the landing pad of the landing station 180, the deployment mechanism 108 can retract-in the tether article to help lower the UAV 150 for landing.

In an exemplary embodiment, the coupler coupled to the positioning device 102 can be configured for use for multiple purposes, like besides executing a landing function, it can also help in carrying logistic load and dropping it vat desired places of delivery. In one more uses, flood lights can be configured with the coupler to illuminate remote area not having light for rescue purposes or capturing videos during low light condition.

In an exemplary embodiment, a remote pilot can have independent links with both the UAV 150 and the positioning device 102. The UAV 150 and the positioning device 102 can operate on a separate RF frequencies and the remote pilot switches between them as per requirements of the operation. The positioning device 102 can perform precise maneuver without relying on the UAV's control systems reducing latency and potential errors. The UAV 150 basically focuses on providing a stable platform, while the positioning device 102 manages close-range operations.

In an exemplary embodiment, the positioning device 102 can be equipped with onboard AI module for precise and independent navigation, object detection, and obstacle avoidance using the inputs from the sensors and other navigational aids. Further, autonomous flight algorithms for local navigation or obstacle avoidance to handle complex environment are also present in the positioning device 102. The manual intervention is allowed if the positioning device 102 encounters challenges or requires precise adjustments.

In an embodiment, the direct command for controlling the operation of the positioning device 102 can be provided through the UAV 150 itself. It may also act as relay station for the commands from the remote pilot to the positioning device where the remote pilot sends commands to the UAV 150, and the UAV 150 relays these commands to positioning device 102 and a feedback from the positioning device 102 is transmitted back to the remote pilot through the UAV 150.

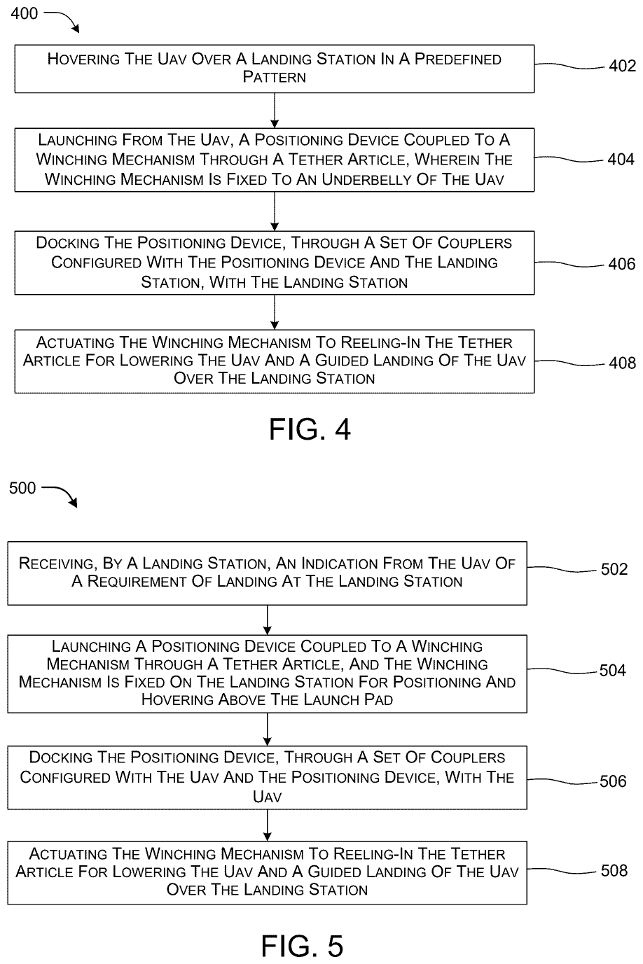

FIGS. 4 and 5 illustrate exemplary block diagrams for the disclosed methods 400 and 500 for landing of the UAV 150 based on the first and second embodiment respectively of the system 100.

In an embodiment, a first method 400 for safe landing of a UAV, such as the UAV 150 shown in FIGS. 2A and 2B, using of the positioning device, such as the positioning device 102 shown in FIGS. 1, 2A and 2B, includes steps of (i) flying 402 the UAV 150 over a landing station, such as the landing station 180 shown in FIGS. 1 to 2B, in a predefined pattern; (ii) launching 404 from the UAV 150, the positioning device 102 coupled to a deployment mechanism, such as deployment mechanism 108 shown in FIGS. 1 to 2B, through a tether article, such as the tether article 104 shown in FIGS. 1 to 2B, wherein the deployment mechanism 108 is fixed to an underbelly of the UAV 150; (iii) docking 406 the positioning device 102, through a set of couplers, such as the couplers 196 shown in shown in FIGS. 1 to 2B, configured with the positioning device 102 and the landing station 180, with the landing station 180; and (iv) actuating 408 the deployment mechanism 108 to retract-in the tether article 104 for lowering the UAV 150 and a safe landing of the UAV 150 over the landing station 180.

In an embodiment, the method 400 may further comprise the step of establishing a communication link between the UAV 150 and the landing station 180 before launching the positioning device 102.

In an embodiment, wherein the step of launching the positioning device may include lowering the positioning device 102 below the UAV 150 to a safe height from the landing station 180 by releasing-out the tether article from the deployment mechanism 108.

In an embodiment, the method 400 may further comprise the step of: aligning the positioning device 102, using one or more of sensors, GPS system and navigation means, which enable the positioning device 102 to autonomously navigate, and position itself over the landing station 180 for docking with the landing station 180.

In an aspect, the present disclosure provides an alternate method 500 for the second alternate implementation of the system 100, where the method 500 includes the steps of (i) receiving 502, by a landing station, such as the landing station 180 shown in FIGS. 1, 3A and 3B, an indication from a UAV 150, such as the UAV 150 shown in FIGS. 3A and 3B, of a requirement of landing at the landing station 180; (ii) launching 504 a positioning device, such as the positioning device 102 shown in FIGS. 1, 3A and 3B, coupled to a deployment mechanism, such as the deployment mechanism 108 shown in FIGS. 1, 3A and 3B through a tether article, such as the tether article 104 shown in FIGS. 1, 3A and 3B, where the deployment mechanism 108 is fixed on the landing station 180, for positioning and hovering of the positioning device 102 below the UAV 150; (iii) docking 506 the positioning device 102, through a set of couplers, such as the couplers 106 shown in FIGS. 1, 3A and 3B, configured with the UAV 150 and the positioning device 102, with the UAV; and (iv) actuating 508 the deployment mechanism 108 to retracting-in the tether article 104 for lowering the UAV 150 and a guided landing of the UAV 150 over the landing station 180.

In an embodiment, the step 502 of receiving the indication of a requirement of landing of a UAV 150 at the landing station 180 can be based on the landing station 180 receiving a signal from the UAV 150, or based on identifying the incoming UAV 150 independent of any signal from the UAV 150 through a sensor not limited to image sensor, proximity sensor, or any combination thereof. These sensors can be deployed on the landing station 180.

In an embodiment, the step of identifying the incoming UAV 150 independent of any signal from the UAV 150 can be based on a predefined pattern of flying of the UAV 150 over the landing station 180, or based on the UAV 150 flying over the landing station 180 near a certain threshold distance from the landing station 180.

In an embodiment, the method 500 may further comprise the step of: aligning the positioning device 102, using one or more of sensors, GPS system and navigation means, which enables the positioning device 102 to autonomously navigate, and position itself under the UAV 150 for docking with the UAV 150.

Thus, the present disclosure provides a simple, easy installable solution for facilitating an assisted and guided landing of the UAV 150 in limited space using a positioning device 102 suchas a mini UAV, tethered with landing station 180 or with the UAV 150 itself. Navigational signals required by the positioning device 102 for aligning and positioning with the landing station 180 or the UAV 150 are processed with artificail intelligence. The couplers 106 and the deployment mechanism 108 helps to bring the UAV 150 closer to the landing station 180 for a safe landing.

It is to be appreciated by a person skilled in the art that while various embodiments of the present disclosure have been elaborated for landing of an UAV 150 using positioning device 102, however, the teachings of the present disclosure are also applicable for other types of applications as well, and all such embodiments are well within the scope of the present disclosure. The methods for landings are also equally implementable in other space as well, and all such embodiments are well within the scope of the present disclosure without any limitation.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

### ADVANTAGES OF THE INVENTION

The present disclosure provides a system and methods for efficient landing of unmanned aerial vehicles in limited areas like rugged terrains and moving objects, under difficult environmental conditions.

The present disclosure provides systems and methods for guided landing of UAVs using a tether.

The present disclosure provides improved and more efficient system and method for guided landing of UAVs using a tether.

The present disclosure provides a system that works autonomously for a safe landing of a UAV under difficult environmental conditions.

1. A system for safe landing of an UAV, the system comprising:
a deployment mechanism;
a tether article operatively coupled to the deployment mechanism for being released and retracted by the deployment mechanism; and
a positioning device coupled to a free end of the tether article:
wherein, upon detecting a requirement for landing of the UAV, the positioning device is configured to create, using the tether article, a tether link between the UAV and a landing station such that on creation of the tether link, the deployment mechanism retracts in the tether article to cause the UAV to be moved to the landing station.

2. The system of claim 1, comprising a coupling mechanism having a pair of couplers to facilitate creation of the tether link between the UAV and the landing station.

3. The system of claim 2, wherein deployment mechanism is fixed to the landing station, and the set of couplers are configured with an under belly of the UAV and an upper side of the positioning device to facilitate coupling of the positioning device with the UAV such that the set of couplers enable coupling of the positioning device to the UAV thereby establishing the tether link between the UAV and the landing station.

4. The system of claim 2, wherein the deployment mechanism is fixed to under belly of the UAV, and the set of couplers are configured with under belly of the positioning device and the landing station respectively, such that the set of couplers enable coupling of the positioning device to the landing station thereby establishing the tether link between the UAV and the landing station.

5. The system of claim 3, wherein the coupling mechanism is at least one of a magnetic couplers, spring loaded connectors, suction cups, and mechanical interlocking device to securely couple the positioning device with the UAV or the landing station, once the positioning device is in close proximity of the UAV or the landing station.

6. The system of claim 3, wherein the positioning device is any of a mini UAV, an aerostat and a balloon, equipped with sensors, a GPS system and navigation means to autonomously navigate and position itself above the landing station or under the UAV.

7. The system of claim 6, wherein the positioning device comprises a controller, a communication module, sensors, GPS receiver, a camera, to execute command received from the UAV, and wherein the UAV and the positioning device remain in communication with each other through designated radio frequency.

8. The system of claim 7, wherein the controller is configured to use artificial intelligence for precise and independent control of navigation means of the positioning device based on the shared real-time data from the UAV or the landing station.

9. A method for safe landing of an UAV, the method comprising steps for:
flying the UAV over a landing station at a certain threshold distance from the landing station;
launching from the UAV, a positioning device coupled to a deployment mechanism through a tether article, wherein the deployment mechanism is fixed to an underbelly of the UAV;
docking the positioning device, through a set of couplers configured with the positioning device and the landing station, with the landing station; and
actuating the deployment mechanism to retract-in the tether article for lowering the UAV and a safe landing of the UAV over the landing station.

10. The method of claim 9, comprising the step of establishing a communication link between the UAV and the landing station before launching the positioning device.

11. The method of claim 9, wherein the step of launching the positioning device includes lowering the positioning device below the UAV to a safe height from the landing station by releasing-out the tether article using the deployment mechanism.

12. The method of claim 9, comprising the step of aligning the positioning device, using one or more of sensors, GPS system and navigation means, which enable the positioning device to autonomously navigate, and position itself over the landing station for docking with the landing station.

13. A method for safe landing of an UAV, the method comprising steps for:
receiving, by a landing station, an indication of a requirement of landing at the landing station;
launching a positioning device coupled to a deployment mechanism through a tether article, wherein the deployment mechanism is fixed on the landing station, for positioning and hovering of the positioning device below the UAV;
docking the positioning device, through a set of couplers configured with the UAV and the positioning device, with the UAV; and
actuating the deployment mechanism to retracting-in the tether article for lowering the UAV and a guided landing of the UAV over the landing station.

14. The method of claim 13, wherein the step of receiving the indication of the requirement of landing of a UAV at the landing station is based on the landing station receiving a signal from the UAV, or based on identifying the incoming UAV through a sensor located at the landing station.

15. The method of claim 14, wherein the step of identifying the incoming UAV independent of any signal from the UAV is based on a predefined pattern of flying of the UAV over the landing station, or based on the UAV flying over the landing station near a certain threshold distance from the landing station.

16. The method of claim 13, comprising the step of aligning the positioning device, using one or more of sensors, GPS system and navigation means, which enable the positioning device to autonomously navigate, and position itself under the UAV for docking with the UAV.

17. (canceled)

18. The system of claim 4, wherein the coupling mechanism is at least one of a magnetic couplers, spring loaded connectors, suction cups, and mechanical interlocking device to securely couple the positioning device with the UAV or the landing station, once the positioning device is in close proximity of the UAV or the landing station.

19. The system of claim 4, wherein the positioning device is any of a mini UAV, an aerostat and a balloon, equipped with sensors, a GPS system and navigation means to autonomously navigate and position itself above the landing station or under the UAV.
